(19) United States
(12) Patent Application Publication
(10) Pub. No.: US 2008/0107082 A1
(43) Pub. Date: May 8, 2008

(54) Mobile communication apparatus

(75) Inventors: Yoichiro Igarashi, Kawasaki (JP); Mitsunori Fukazawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/979,458

(22) Filed: Nov. 2, 2007

(30) Foreign Application Priority Data
Nov. 7, 2006 (JP) 2006-301890

(51) Int. Cl. H04Q 7/00

(52) U.S. Cl. 370/331

(57) ABSTRACT

The present invention provides a mobile communications apparatus, which optimizes handover timing and avoids communications interruptions with a base station. A handover timing calculating function 23, which computes a handover timing, is provided in either a mobile station 10 or base station A (20-A) or B (20-B). The handover timing calculating function 23 sets handover timing from a handover point “G”, which has reception power as a reference, to a point in time “H”, which moves up the required boot-up time for an application that the mobile station 10 is at least currently using.

### CROSS-REFERENCE TO RELATED APPLICATIONS

This application is based upon and claims the benefit of priority from the prior Japanese Patent Application No. 2006-301890, filed on Nov. 7, 2006, the entire contents of which are incorporated herein by reference.

### BACKGROUND OF THE INVENTION

1. Field of the Invention

The present invention relates to a mobile communications apparatus, and more particularly to a mobile communications apparatus, which seeks appropriate handover timing and avoids an interruption of communications with a base station.

2. Description of the Related Art

A mobile communications apparatus is constituted so as to ensure the continuation of communications between a mobile wireless station (hereinafter, mobile station) and a plurality of fixed wireless stations (hereinafter, base stations) while sequentially switching base stations via “handovers”.

However, communications may be interrupted temporarily if connection processing between the mobile station and a certain base station cannot be completed within a prescribed time (within the scope of communication exchanges with the base station). A malfunction like this is apt to occur, for example, in an urban area, where the distance between base stations is short, and, at the same time, the velocity of the mobile station is relatively fast.

To deal with this problem conventionally, for example, there is disclosed a mobile communications apparatus, which carries out accurate handover control by equalizing the levels of received signals in short periods during fast movement (for example, Japanese Patent Laid-open No. 2002-27521, referred to hereinafter as Patent Literature 1).

Further, there is also disclosed a handover control method and the like, which, prior to mobile communications handover processing, reserves a resource of a base station within a prescribed range on the basis of prioritization to realize smooth handover (for example, Japanese Patent Laid-open No. 2004-266713).

Furthermore, there have also been disclosed a mobile communications system, which changes the handover initiation level in accordance with the velocity of a mobile communications terminal (for example, Japanese Patent Laid-open No. 2004-260477), a mobile communications system, which accurately carries out a handover operation based on map information and location information from a mobile communications terminal (for example, Japanese Patent Laid-open No. 2004-228881), and a mobile communications system, which shortens handover processing time by shortening the equalization time when measuring reception radio intensity (for example, Japanese Patent Laid-open No. 10-322747).

However, in order for the mobile station to reliably receive an application service provided by the base station, mobile station authentication processing and a guarantee that the application will continue to operate are required prior to service execution. None of the prior art according to the above-mentioned patent literature gives any consideration to this kind of application condition processing. Therefore, in this prior art, there are times when communications are interrupted because handover-based connection processing, to include processing at the application condition, cannot be completed even when the mobile station is within communication range of the base station, and because a connection cannot be established for communications with the base station to communicate at the target place.

### SUMMARY OF THE INVENTION

Accordingly, with the foregoing in view, an object of the present invention is to provide a mobile communications apparatus, which optimizes handover timing, and more particularly to optimize handover initiation timing, which anticipates the procedure time required until user data is transmitted and avoids communication interruptions with a base station.

To achieve the above-mentioned object, according to a first embodiment of the present invention, a mobile communication apparatus for communicating with a base station, having a setting unit which sets to a handover start-up timing from a first base station to a second base station a time which moves up by a start-up required time of an application, which is executed by a server to which the mobile communication apparatus is connected via either of the base stations and which is at least currently used, with respect to a estimated time for reaching a switching point of a radio intensity between the radio intensity from the first base station, with which the mobile communication apparatus communicates currently, and the radio intensity of the second base station, with which the mobile communication apparatus communicates next.

Further, to achieve the above-mentioned object, according to another embodiment of the present invention, a mobile communication apparatus for communicating with a base station, having a notification unit which detects a velocity and acceleration of the mobile communications apparatus, and notifies a first base station, with which the mobile communication apparatus communications currently, of the detected velocity and acceleration; and a setting unit which receives a handover start-up timing from a second base station, calculated by the second base station on the basis of the velocity and acceleration, by selected by the first base station the second base station, with which the mobile communication apparatus communicates next, based on the velocity and acceleration notified to the first base station, and by notified from the first base station to the second base station of the velocity and acceleration, and sets as a handover start-up timing for the second base station.

Furthermore, to achieve the above-mentioned object, according to another embodiment of the present invention, a base station for communicating with a mobile communication apparatus, having a receiving unit which receives a velocity information of a mobile communication apparatus from the mobile communications apparatus; a calculating unit which calculates as a handover start-up timing of the mobile communication apparatus a time which moves up by a start-up required time of an application, which is executed by a server which the mobile communication apparatus is connected via either of the base station and which is at least currently being used, with respect to a estimated timing for reaching a radio intensity switching point, which is determined based on the received velocity information, of a radio intensity of a second base station with which the mobile communication apparatus communicates next; and a sending unit which sends the calculated handover start-up timing to the mobile communications apparatus.

Furthermore, to achieve the above-mentioned object, according to another embodiment of the present invention, a mobile communications method for communicating a mobile communication apparatus with a base station, having a step of setting to a handover start-up timing from a first base station to a second base station a time which moves up by a start-up required time of an application, which is executed by a server to which the mobile communication apparatus is connected via either of the base stations and which is at least currently used, with respect to a estimated time for reaching a switching point of a radio intensity between the radio intensity of the first base station, with which the mobile communication apparatus communicates currently, and radio intensity of the second base station, with which the mobile communication apparatus communicates next.

Furthermore, anything that applies a component, expression, or arbitrary combination of components of the present invention to a method, apparatus, system, computer program, recording medium, data structure or the like is also valid as an aspect of the present invention.

According to the present invention, it is possible to provide a mobile communications apparatus that optimizes handover timing, and avoids a communications interruption with a base station.

### BRIEF DESCRIPTION OF THE DRAWINGS

FIG. 1 shows an example of a constitution in which a fixed wireless station (base station) and group of application servers are connected to a network;

FIG. 2 shows an example of a constitution of a mobile wireless station (mobile station);

FIG. 3 shows an example of a constitution of a fixed wireless station (base station);

FIG. 4 is a flowchart showing an example of processing which determines handover timing;

FIG. 5 is a diagram for illustrating a handover timing;

FIG. 6 is a flowchart showing an example of processing which transmits relayed data in a turning direction of a mobile wireless station (mobile station);

FIG. 7 is a diagram for illustrating the transmission of relayed data;

FIG. 8 shows the sequence of operations for the entire process;

FIG. 9 shows the sequence of operations for the entire process;

FIG. 10 shows an example of a constitution of a mobile wireless station; and

FIG. 11 shows an example of a constitution of a fixed wireless station.

### DESCRIPTION OF THE PREFERRED EMBODIMENTS

The preferred embodiments of the present invention will be explained herein below by referring to the figures.

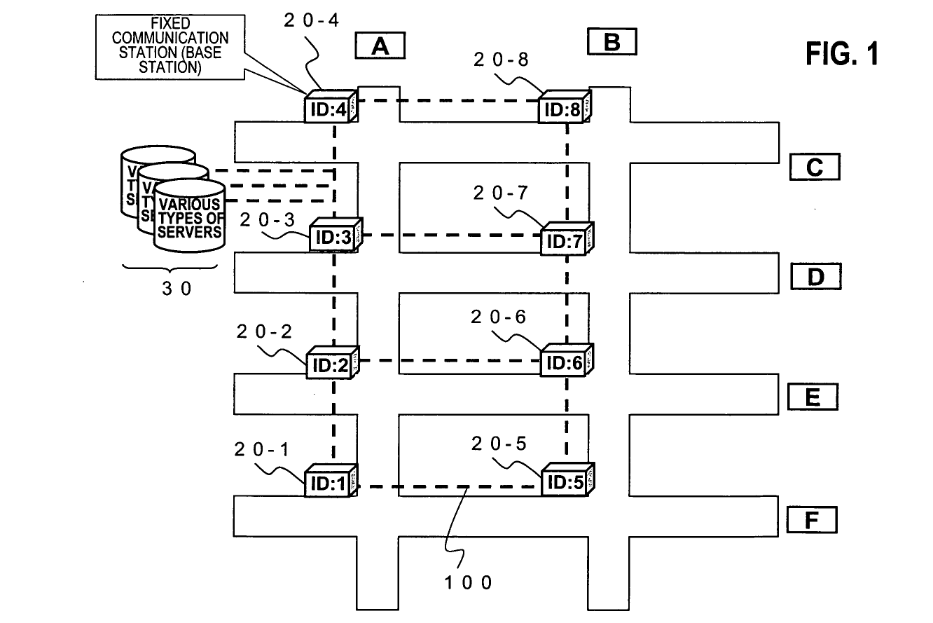

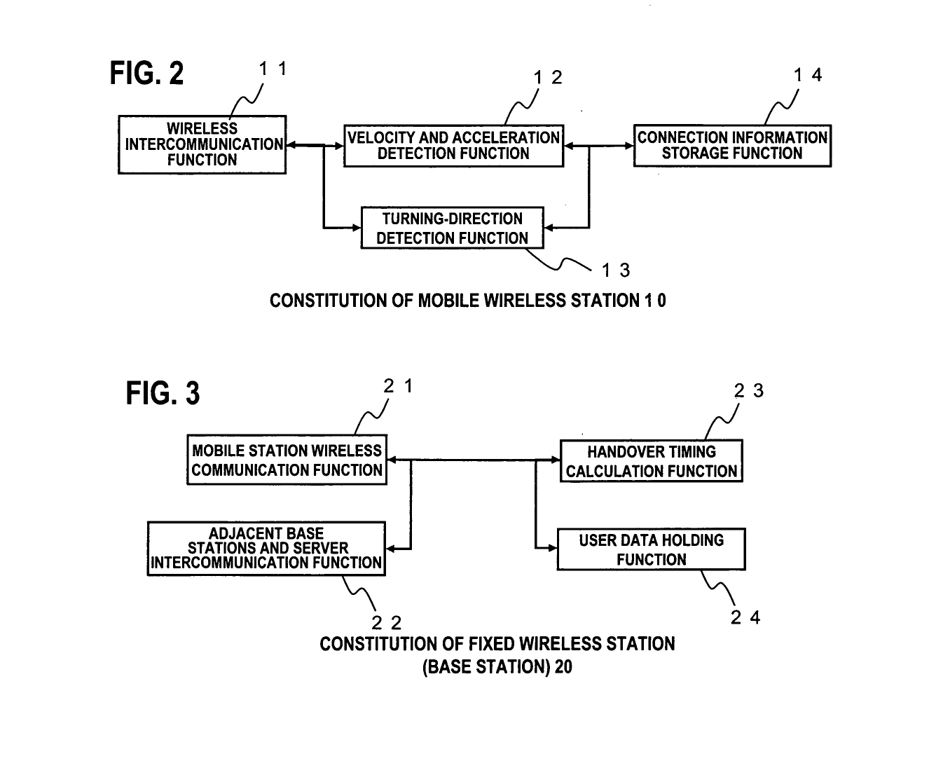

FIG. 1 shows an example of a network configuration, FIG. 2 shows an example of a constitution of a mobile wireless station (mobile station, or mobile communications apparatus), and FIG. 3 shows an example of a constitution of a fixed wireless station (base station).

As shown in FIG. 1, the network configuration according to this embodiment has a plurality of base stations 20 (in the example of FIG. 1, there are eight base stations 20-1 through 20-8), and a group of application servers 30. The respective base stations 20-1 through 20-8 are interconnected via a network 100, and the group of application servers 30 is also connected to the network 100. The constitution example of FIG. 1 supposes roads, in a grid shape, for example, and the base stations 20 (20-1 through 20-8) are disposed at the respective intersections.

The respective base stations 20-1 through 20-8 receive from the application server 30 various application services (traffic information, visibility information based on weather condition), which conform to the traffic situations at the individual points of disposition, and send same to a mobile station.

Further, the respective base stations 20-1 through 20-8 share information that is not location dependent (hereinafter, relayed data), and relay the relayed data pursuant to the movement of the mobile station. Thus, the certain base station 20-1 through 20-8 is adjacent and connected via network 100 to one or more other base stations 20-1 through 20-8. Relaying this relayed data speeds up a connection operation in accordance with a handover.

Furthermore, the respective base stations 20-1 through 20-8 hold identification information (ID) for identifying them from the other base stations 20-1 through 20-8. In addition, in this embodiment, the network 100 connection can be either wired or wireless.

The group of application servers 30 is either computer, which can store information to be delivered to the mobile station (such as an application program, or a program for carrying out an authentication process), or a computer-readable storage medium, which is connected to these computers. The stored information is sent from a base station 20-1 through 20-8 to the mobile station. Consequently, the mobile station is able to receive the application service.

Furthermore, in this embodiment, the group of application servers 30, for example, is constituted by a plurality of servers, such as a service server which stores a service program, and as an authentication server for carrying out the mobile station authentication process. Of course, the group 30 is also constituted by a single server storing information.

Further, the group of application servers 30 holds estimation values of the required processing time at respective application condition (the time for carrying out the authentication process, and the time required for starting up the application), and sends estimation values in accordance with request from the respective base stations 20-1 through 20-8.

A mobile station communicates wirelessly with any of the base stations while moving over the roads in FIG. 1, that is, while being handed over among the respective base stations 20-1 through 20-8.

FIG. 2 shows an example of a constitution of the mobile station 10. The mobile station 10 has a wireless intercommunication function 11, a velocity and acceleration detection function 12, a turning-direction detection function 13, and a connection information storage function 14.

The wireless intercommunication function 11 is an interface for communicating wirelessly between the mobile station 10 and the base station 20.

The velocity and acceleration detection function 12 is a function, which detects the velocity and acceleration of the mobile station 10, and, for example, when the mobile station 10 is an automobile, is equivalent to a sensor (such as a tachometer, or acceleration detection sensor), which detects velocity and acceleration inside the automobile. The detected velocity and acceleration information are sent to the base station 20 from the wireless intercommunication function 11. Furthermore, the velocity and acceleration detection function 12 can also be designed to detect only velocity.

The turning-direction detection function 13 detects the direction that the mobile station 10 is turning. For example, when the mobile station 10 is an automobile, the turning-direction detection function 13 is a steering angle sensor or gyro sensor, and detects turning-direction by detecting the steering angle. The detected turning-direction is sent to the base station 20 from the wireless intercommunication function 11.

The connection information storage function 14 stores information on which base station 20 the mobile station 10 is communicating with currently. The connection information storage function 14 is actually constituted by a memory.

FIG. 3 shows an example of a constitution of the base station 20. The base station 20 has a mobile station wireless communication function 21, intercommunication function of an adjacent base station and application server group 22, a handover timing calculating function 23, and a user data holding function 24.

The wireless communication function 21 carries out wireless communications with the mobile station 10, and the intercommunication function 22 carries out wireless communications between the adjacent base station 20 and the group of application servers 30.

The handover timing calculation function 23 calculates the handover timing of the mobile station 10 based on the velocity and acceleration of the mobile station 10 and the estimation value for the processing time at the application condition. The details are provided later. The calculated handover timing is sent to the mobile station 10 from the wireless communication function 21.

The user data holding function 24 holds user-related information sent from the mobile station 10. The user data holding function 24 is constituted by a memory, which stores this information.

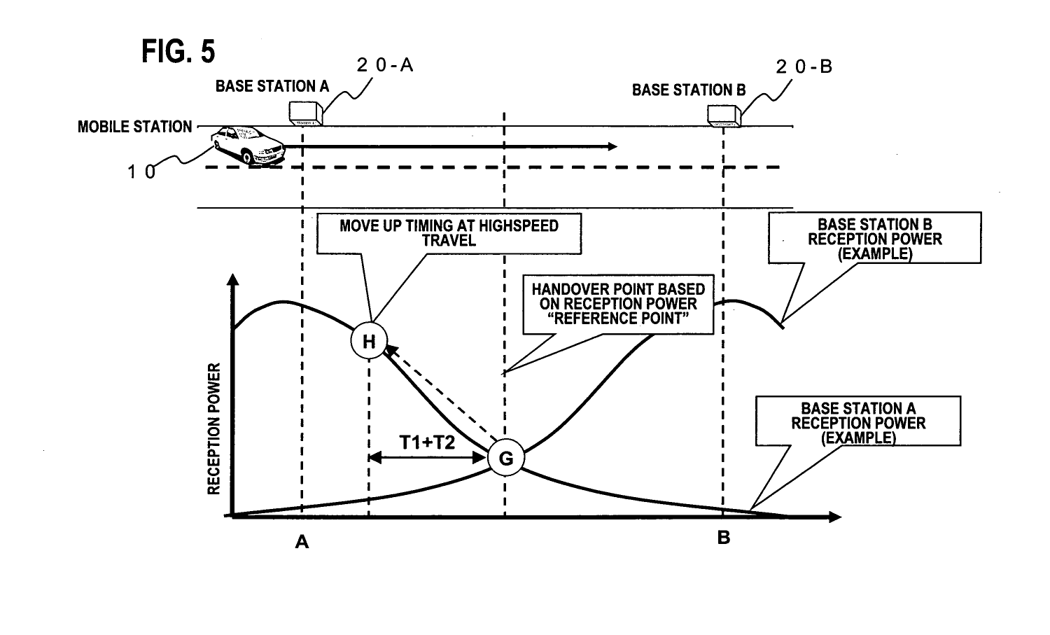

First, handover start-up timing in this embodiment will be explained. FIG. 5 shows an example thereof.

When the mobile station 10 (an automobile in this example) moves from the base station A (20-A) to the base station B (20-B), the reception power level (or radio intensity) from the base station A (20-A) is high when the mobile station 10 is near the base station A (20-A), but gradually lessens as the mobile station 10 moves away. Conversely, the reception power level from the base station B (20-B) steadily becomes higher as the mobile station 10 draws nearer to the base station B (20-B).

As described above, in the prior art, the handover timing of a basic handover is accomplished by the mobile station 10 comparing the two reception power levels of the base station A (20-A) and base station B (20-B), and treating as a trigger a switching point of a radio intensity (a reference point), which is when the reception power level from the base station B (20-B), which is on the route ahead of the mobile station 10, becomes higher (“G” in FIG. 5) than the power level from the base station A (20-A).

However, in actuality, if the handover operation is not started up prior to this handover timing, there are cases that the mobile station 10 cannot start up the communication after switching over. Further, it is also desirable to factor in the processing time required to switch to a high level application and starts up handover sooner than the handover timing “G” (“H” in FIG. 5).

In this embodiment, handover switch timing is treated as start up trigger the time (“H”), which moves up by a time adding the location (or time) of the mobile station 10 after a fixed time, which is calculated from the velocity and acceleration information of the mobile station 10 while moving, to the processing time at the application condition (at least the time from authentication processing until the application is actually capable of being used), with respect to a time at which the mobile station 10 will reach the power level switching point (“G”) estimated from the respective reception power levels of the base station A (20-A) and base station B (20-B).

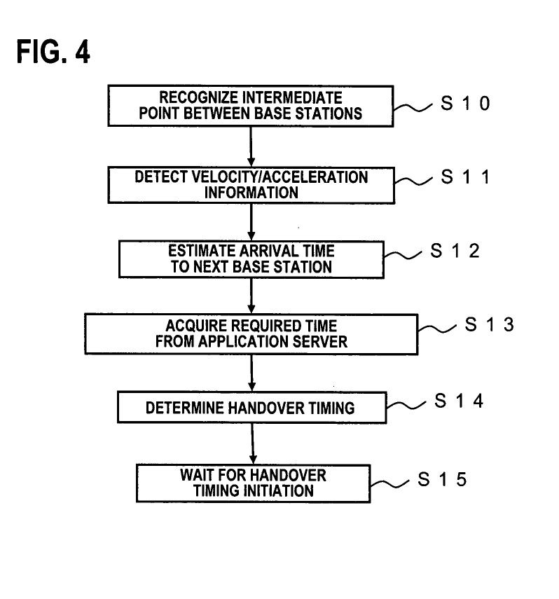

The operation will be explained next. FIG. 4 is an example of a flowchart for calculating the handover timing executed by the handover timing computation function 23.

First, the handover timing computation function 23 recognizes an intermediate point with another base station 20, which is adjacent (S10). When the base station 20-1 is carrying out this process, in S10, for example, the base station 20-1 recognizes an intermediate point between the base station 20-1 and the base station 20-2. Handover is generally carried out such that the mobile station 10 compares the reception power from the first base station 20, with which it is currently communicating, against the reception power from the second base station 20, which is on the route ahead of the mobile station 10, and switches communications to the base station 20 on the route ahead at the timing at which the reception power from the base station 20 on the route ahead becomes higher, that is, the timing at which the reception powers switch places (radio intensity) switching point). Under ideal conditions, this handover point is approximately the intermediate point between the base stations 20. In this embodiment, this intermediate point is called the “reference point” as described in FIG. 5.

Furthermore, since the locations of the respective base stations 20 are fixed, the respective base stations 20 store the information of the radio intensity switching point between the adjacent base stations 20, and the information of the estimated intermediated point, and execute this process by reading the information.

Next, the handover timing computation function 23 detects information related to a moving direction, and velocity and acceleration information from the mobile station 10 (S11). Here, the handover computation function 23 acquires the turning-direction (moving direction) of the mobile station 10 detected by the turning direction detection function 13 of the mobile station 10, and the velocity and acceleration information of the mobile station 10 detected by the velocity and acceleration detection function 12, by way of the wireless communication function 21.

Next, the handover timing calculating function 23 estimates the arrival time of the mobile station 10 at the next base station 20, which exists on the route ahead of the mobile station 10 (S12). For example, when the moving direction of the mobile station 10, which moves in the upwards direction in FIG. 1 from the base station 20-1 of FIG. 1, the base station, which exists in the moving direction of the mobile station 10 and is the closest to base station 20-1, is base station 20-2, which is equivalent to the next base station 20 described hereinabove. Then, based on the velocity and acceleration information received from the mobile station 10, the handover timing calculating function 23 calculates the arrival time at which the mobile station 10 will reach the “reference point” between base station 20-1 and base station 20-2.

Next, the handover timing calculating function 23 acquires from the application server 30 a estimation value for the time required for processing at the application condition (S13). That is, in S13, the handover timing calculating function 23 acquires from the application server 30, in accordance with the type of application (application service being received) that the mobile station 10 is communicating with via the base station 20-1, the estimation value of the time required until this in-progress application can be utilized by the next base station (the time for carrying out authentication processing, and the time needed for booting up the equivalent to the time difference between G and H of FIG. 5.

Then, based on the arrival time at the “reference point” (S12) and the estimation value (S13), the handover timing calculating function 23 determines the timing for starting up handover at the mobile station 10 (S14). By virtue of the mobile station 10 stating up handover at this determined timing makes it possible for the connection between the mobile station 10 and the application server 30 to be completed, that is, creates a state in which the application can be utilized, prior to reaching the handover-destination base station 20, thereby making it possible to guarantee that the application will continue to run on the mobile station 10 when the serving station switches from the first base station 20 to the second base station 20 in line with the movement of the mobile station 10.

Thereafter, the base stations 20 wait for the commencement of handover timing from the mobile station 10 (S15).

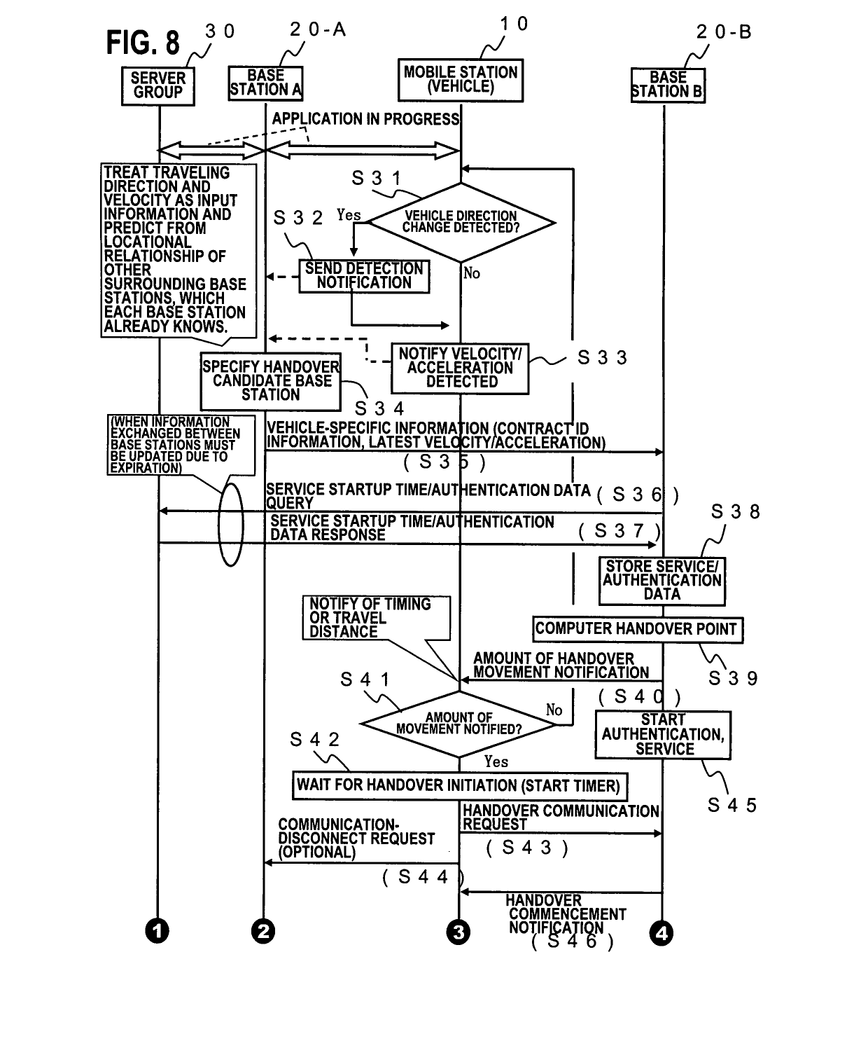

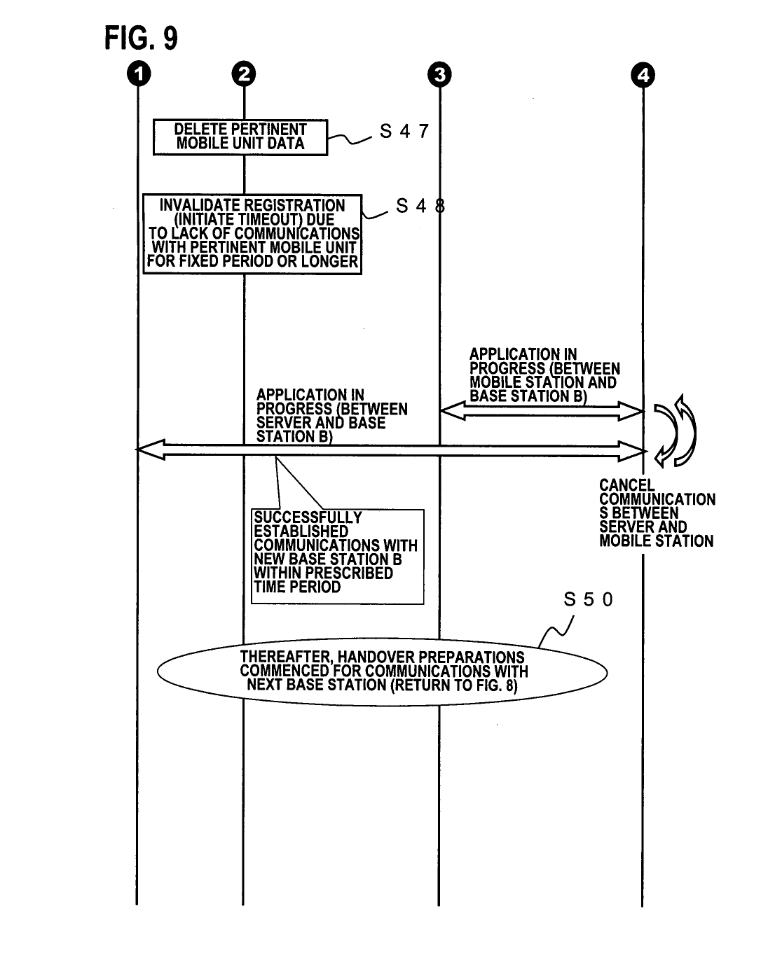

Furthermore, the processing shown in FIG. 4 will be explained in detail herein below using FIGS. 8 and 9.

Thus, in this embodiment, since the location of the mobile station 10 subsequent to a fixed time period, which takes into account velocity and acceleration, is factored together with the processing time at the application condition, and the handover start up timing is set as timing “H” of FIG. 5, which is moved up from the switching point “G” shown in FIG. 5, the mobile station 10 can continue receiving authentication processing and the application service subsequent thereto without interrupting communications.

In other words, since handover timing is set by also taking into account the start-up time required until the application service can actually be executed, it is possible to avoid disruption of communications due to handover timing at the application condition not catching up to the handover timing of the wireless link.

Further, the handover timing calculating function 23 calculates the location of the mobile station 10 using not only the velocity information of the mobile station 10, but the acceleration information as well. With velocity information alone, the premise is that the mobile station 10 is moving at a fixed speed, so that being able to estimate the location of the mobile station 10 with accuracy by taking acceleration into account, in turn, makes it possible to compute accurate handover timing.

Furthermore, the handover timing (FIG. 5 “G”) according to this embodiment can also be depicted by location (or distance) in addition to time. The corresponding location can also be calculated from the amount of time realized by moving the timing up based on the velocity and acceleration information of the mobile station 10.

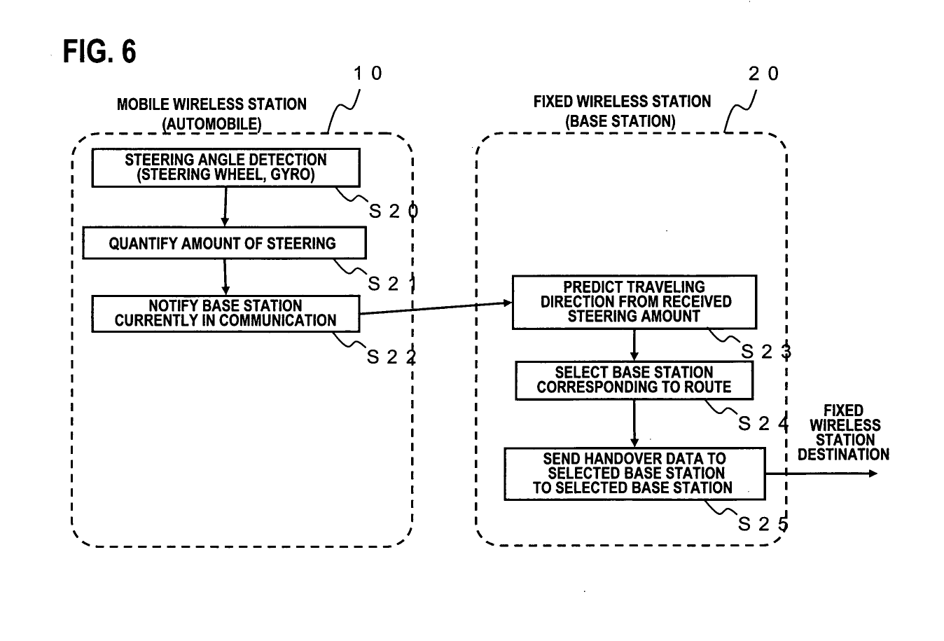

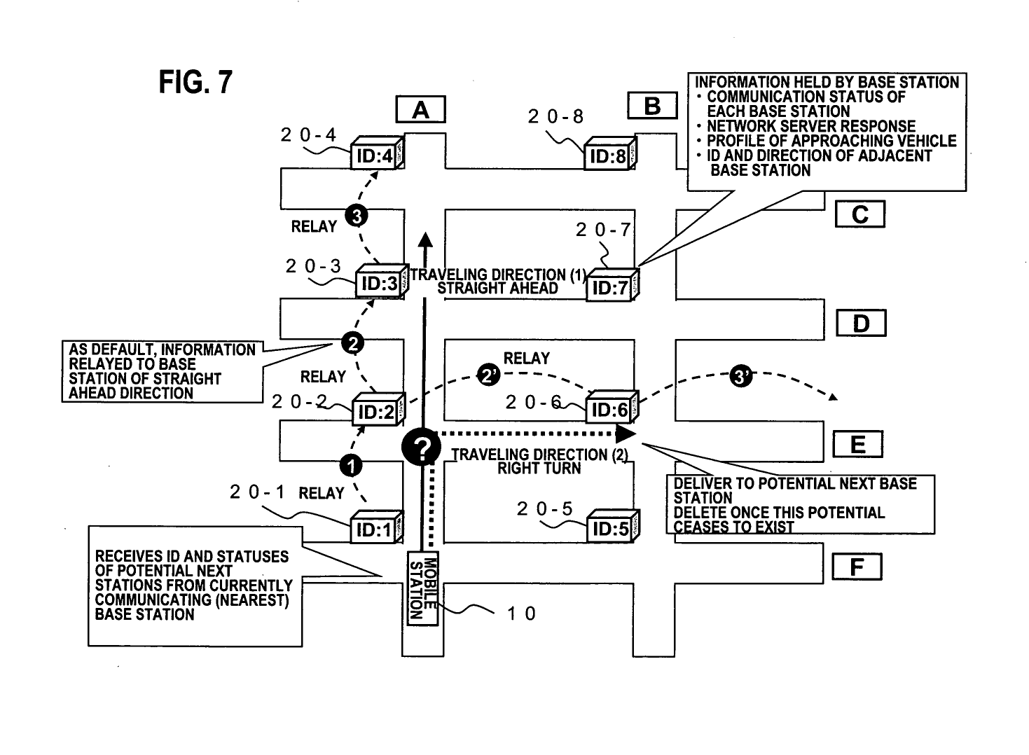

Next, an example of relayed data being relayed (sent) based on a turning-direction of the mobile station 10 will be explained by referring to FIGS. 6 and 7.

FIG. 6 is a flowchart showing an example of processing executed by a mobile station 10 and base station 20. First, the turning-direction detection function 13 detects the steering angle of the mobile station 10 (S20). In accordance with this process, the turning-direction detection function 13 detects a change in the traveling direction of the mobile station 10.

Next, the amount of steering is quantified to make it possible to evaluate and determine a change of route from the detected steering angle (S21), and the wireless intercommunication function 11 notifies the quantified steering amount to the base station 20 with which communications are currently being carried out (S22).

The base station 20, which receives this notification, infers the traveling direction of the mobile station 10 from the steering amount (S23), and selects a base station 20, which is in this direction (S24). The base station 20 references either location information of other base stations around itself, or information on intermediate points with these other base stations, which has been stored in advance, and selects a base station 20, which corresponds to the direction of travel of the mobile station 10. The inferred traveling direction (S23) and the selection of a base station 20 (S24), for example, are processed by either the handover timing calculation function 23 or the wireless communication function 21.

Then, the adjacent base stations/server intercommunication function 22 sends the handover data (relayed data) to the selected base station 20 (S25).

When processing the traveling direction inference (S23) and the base station 20 selection (S24), there is generally little confusion in making a determination at a simple intersection like a perpendicular crossroads, but in the case of an intersection having a complex shape, sensor accuracy or the like may not be capable of ensuring the accuracy of a traveling direction determination. In this embodiment, a plurality of base stations 20 can be selected as candidates (S24), and in this case, relayed data is sent to all the candidate base stations 20 (S25).

FIG. 7 is a diagram showing a specific example in which relayed data is sent on the basis of the turning-direction of the mobile station 10. In this example, too, a grid-like road is assumed as in FIG. 1, and base stations 20 (20-1 through 20-8) are installed at each intersection.

It is supposed that a base station 20 stores relayed data using the user data holding function 24 until authentication information, an application program, and other such relayed data is received from either an application server 30 or the base station 20, which the mobile station 10 passed and communicated with immediately prior (base station 20 behind the mobile station 10), and communication ends.

In sequence, first, the mobile station 10 moves in the direction from the bottom to the top of FIG. 7 while communicating with the nearby base station 20-1 at “ID:1”.

Next, the mobile station 10 enters an intersection, which is that of base station 20-2 at “ID:2”. At this point in time, the mobile station 10 communicates with base station 20-2. There are two possible scenarios at this time, the one being that the mobile station 10 will continue to go straight ahead, and the other being that the mobile station 10 will make a right turn. The mobile station 10 could also make a left turn.

As shown in FIG. 6, upon receiving the steering amount notification from the mobile station 10, base station 20-2 determines that the mobile station 10 will proceed straight ahead, and the base station 20-2 at “ID:2” relays application data (relayed data) to the base station 20-3 at “ID:3”. Therefore, when the mobile station 10 proceeds straight through the intersection of base station 20-2, and the mobile station 10 communicates with base station 20-3 at “ID:3”, the data required for base station 20-3 to communicate with the mobile station 10, such as, for example, authentication information for the application server 30 with which the mobile station 10 is communicating, and the application information currently being used, is already in place.

Conversely, when the mobile station 10 makes a right turn, the steering amount is notified to base station 20-2 at “ID:2” by the mobile station 10 as shown in FIG. 6 (S20 through S22), and base station 20-2 detects the right turn of the mobile station 10 (S23). Using the detection of this right turn as a trigger, base station 20-2 cancels the relay of relayed data to base station 20-3 at “ID:3” and relays same to base station 20-6 at “ID:6” (S25).

Furthermore, since handover timing is notified from both of the base stations 20 until the mobile station 10 approaches the base station 20 on the route ahead of the mobile station 10 (either 20-3 or 20-6), the mobile station commences handover based on this timing whether the mobile station 10 proceeds straight ahead or turns right.

Then, when handover is initiated, a connection operation is executed by the base station 20 of the switching-destination (route ahead of the mobile station 10) based on application data obtained via the relay that preceded the connection.

Thus, since application data is relayed by the respective base stations 20 in advance of mobile station 10 connection (prior to handover being carried out), compared to an ordinary handover operation in which no relaying is carried out, application boot-up processing can be carried out in a base station in advance of a handover request signal from a mobile station, thereby making it possible to omit the time required for application boot-up in the base station 20 subsequent to handover initiation, and enabling the time required for handover itself to be shortened.

Furthermore, the application data relayed between the base stations 20, for example, can include an authentication key for authenticating the mobile station 10, service class and other such data, and data indicating the type of application service being used.

Further, an expiration date, number of relays (number of transmissions) capable of being relayed, and other such information can be set in this data, and only that application data to be relayed that satisfies these settings will be sent. Data that does not satisfy a setting might also be sent by attaching information to the effect that the data is invalid. Furthermore, even if data does not satisfy a setting, data required by the base station 20 on the route ahead of the mobile station 10 can also be acquired from an application server 30 on the network 100.

Relayed data can also include data other than applications data, and, for example, can be constituted to relay the above-mentioned handover timing. Thus, the constitution can be such that a GPS (Global Positioning System) receiver, which receives signals from GPS satellites, is provided in each base station 20, timing is synchronized, and made to accurately coincide with handover timing. When the network 100 is an IP network, a time synchronization protocol such as NTP (Network Time Protocol) can be used.

Further, relayed data is relayed between the respective base stations 20, and this relayed data can be updated. At this time, the respective base stations 20 acquire the latest relayed data by querying a server 30. In so doing, the relayed data is acquired by the exchange of messages between the base station 20 and the server 30.

For example, this message includes message type, user (mobile station 10) identification information, information related to the serving base station 20, and the latest updated relayed data.

Next, the operational sequence of the entire process, which is carried out between a mobile station 10, base stations 20, and an application server 30, will be explained using FIGS. 8 and 9. Since this explanation partially duplicates the above explanation, this portion of the explanation will be simplified.

First, as shown in FIG. 8, the mobile station 10 is engaged in application communications with base station A (20-A). Furthermore, it is supposed that base station A (20-A) is holding various information, such as an identifier (contract information, and so forth), which specifies the mobile station 10, the application (program) currently being used, and the traveling direction of the mobile station 10, from the point in time at which a connection commences.

The mobile station 10 determines whether or not the steering angle sensor or gyro sensor, which is provided inside the mobile station 10, has detected a change in direction (turning-direction) of the mobile unit (mobile station 10) (S31). This process corresponds to S20 of FIG. 6.

When a change of direction has been detected (S31: YES), the mobile station 10 delivers a detection notification to base station A (20-A) with which it is communicating (S32). This process corresponds to S21 and S22 of FIG. 6.

When a change of direction has not been detected (S31: NO), or subsequent to the detection notification delivery (S32), the mobile station 10 detects velocity and acceleration, and delivers the detected information to base station A (S33). This process corresponds to S11 of FIG. 4.

Conversely, base station A (20-A) receives the notification of S32, and selects a base station 20 as a handover candidate (S34). Furthermore, either one or a plurality of base stations 20 can be selected as candidates in S34. When a change-of-direction detection notification is received from the mobile station 10, base station A (20-A) selects a base station 20 based on this notification (corresponds to S23 and S24 of FIG. 6). For example, it selects the base station 20 that is directly ahead of the mobile station 10 as the default, and upon receiving a notification of a change of direction, selects on the basis of this notification, a base station 20 located ahead in the changed direction.

Next, base station A (20-A) sends the relayed data, which the user data holding function 24 holds from the time a connection with the mobile station 10 commences, to base station B (20-B), which was selected as a candidate (S35). In a case in which a plurality of base stations were selected as candidates in S34 (a state in which it is not possible to specify one base station), the relayed data is sent to each of these base stations.

Next, base station B (20-B), which is the switching destination of a handover, based on received vehicle-specific information, queries and acquires from an application server 30 application condition processing times, such as the boot-up time of the application service the mobile station 10 is currently using, and the authentication processing time. Further, when it is necessary to update the relayed data that has been exchanged between the base stations A (20-A) and B (20-B) due to expiration or the like, this update is acquired in accordance with querying (S36, S37).

Then, base station B (20-B) stores the application service (program) and authentication data acquired from an application server 30 and base station A (20-A) (S38).

Next, base station B (20-B) computes handover timing (S39). This process corresponds to S14 of FIG. 4.

Next, base station B (20-B) notifies the computed handover timing (the correction quantity of the handover location (point in time)) to the mobile station 10 (S40).

Furthermore, subsequent to handover timing computation (S39), this timing can be transferred to base station A (20-A) with which the mobile station 10 is communicating via the network 100, and notified to the mobile station 10 from base station A (20-A) (S40). In addition, base station A (20-A) can also execute the processing of S36, S37 and S39, and compute handover timing, and base station A (20-A) can notify this timing to the mobile station 10.

Further, when a plurality of base stations are selected as candidates in S34, relayed data is sent to the plurality of base stations in S35, so that the respective base stations, which received relayed data from base station A, respectively carry out the processing from S36 through S40.

Next, the mobile station 10 checks whether or not the amount of handover movement has been notified (S41), and when this amount has been notified, stores the contents of this notification in a storage medium (S41: YES), and the mobile station 10 waits for handover initiation (S42). As a waiting method, for example, the mobile station 10 can activate a timer.

Conversely, when the amount of movement has not been notified (S41: NO), processing returns once again to S31, and the processes described hereinabove are repeated. Subsequent processing is held up until the amount of movement is notified (S41: YES).

Next, the mobile station 10, upon being notified of the handover timing in S41, requests handover communications with base station B (20-B) on the route ahead of the mobile station 10 (S43), and requests that base station A (20-A), which is located behind the mobile station 10, break off communications (S44). Furthermore, the disconnect request of S44 does not always have to be carried out.

Furthermore, when base station A sends relayed data to a plurality of base stations in S35, the mobile station 10 receives the amount of handover movement notifications of S40 from the plurality of base stations. In this case, the mobile station 10 composes the information and handover movement amounts received from the respective base stations correspondent, stores same in a storage medium, specifies one base station by reading out from the storage medium information related to the base station for which reception power becomes stronger pursuant to the progress (movement) of the mobile station 10, and makes this specified base station the handover destination.

A base station B (20-B), which is on the route ahead of the mobile station 10, notifies the mobile station 10 that handover processing corresponding to the handover communication request from the mobile station 10 has commenced (S46).

Furthermore, in the base station B, authentication processing and application service boot-up processing is carried out based on data stored in a storage unit in S38, prior to receiving the handover communication request of S43 from the mobile station 10 (S45). Furthermore, the processing of S45 can be carried out anywhere between S38 and S46, but to shorten the time from when the mobile station 10 initiates handover processing until handover processing is complete, it is desirable that S45 processing be carried out before receiving a handover communication request from the mobile station 10.

Conversely, the base station A (20-A), which is located behind the mobile station 10, deletes data related to the pertinent mobile station 10 (S47 of FIG. 9), and when a communication disconnect request is not made by the mobile station 10 to the rear-located base station (base station A) in S44, instead of carrying out S47, base station A determines if a prescribed amount of time has passed since communications were carried out between base station A and the mobile station 10, and when there has been no communications with the pertinent mobile station 10 for a fixed period of time, invalidates (times out) the registration (S48).

Furthermore, when base station A sends relayed data to a plurality of base stations in S35, since only one of the plurality of base stations, which are the receiving side, receives the communication request of S43 from the mobile station 10, relayed data deletion processing is required in a base station that did not receive same. Therefore, the respective base stations, which received relayed data in S35, for example, activate timers upon receiving the relayed data of S35, and delete the relayed data, which was stored in a storage medium in S38, when the communication request of S43 is not received within a specified period of time. Further, the respective base stations can also activate timers when they compute the handover point in S39 (the time that the mobile station 10 will arrive at the handover point), and delete the relayed data when the communication request of S43 is not received once this computer arrival time has passed.

Then, the mobile station 10 carries out application communications with base station B (20-B), and, as needed, application communications are carried out between base station B (20-B) and an application server 30.

Thereafter, handover preparations are made for communications with the next base station 20 (S50), and the processing shown in FIG. 8 is executed once again.

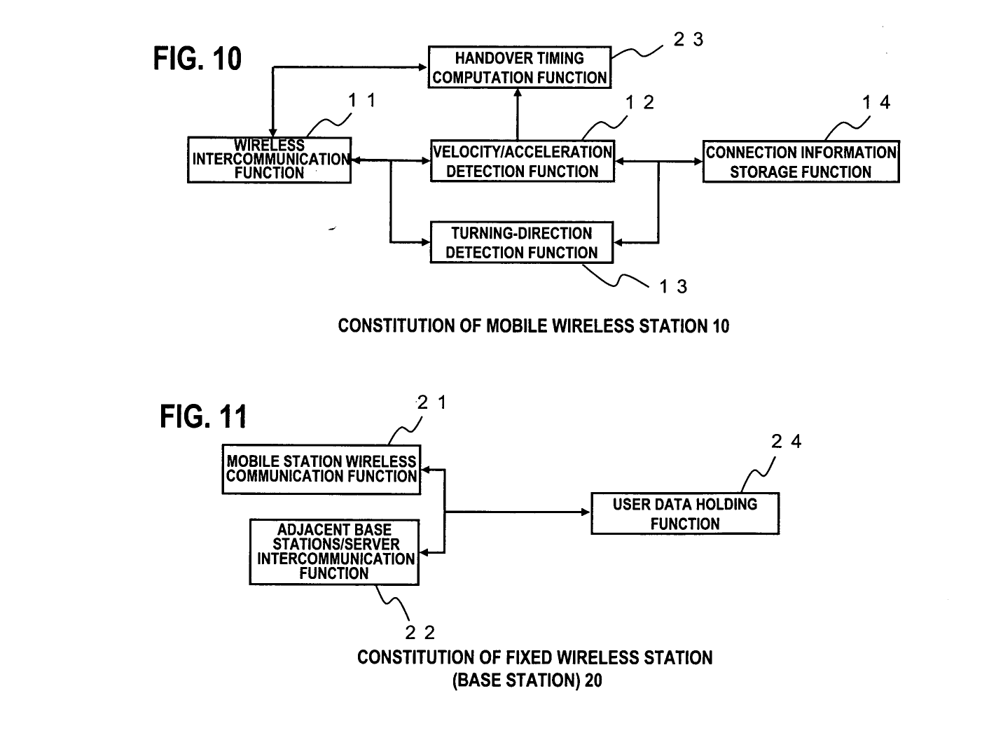

Next, examples of other mobile station 10 and base station 20 constitutions will be explained by referring to FIGS. 10 and 11. In each of the examples explained hereinabove, the handover timing calculation function 23 is explained as having been provided on the base station 20 side, but, as shown in FIG. 10, this handover timing calculating function 23 can also be provided on the mobile station 10 side.

The handover timing calculating function 23 is inputted with mobile station 10 velocity and acceleration information from the velocity/acceleration detection function 12, and is also inputted with application condition processing time information (estimated value of time required for processing) from an application server 30 via the network 100 by way of a base station 20, wireless communications network, and wireless intercommunication function 11. The computation process computes an amount equivalent to a moved-up time (or distance) the same as in the examples described hereinabove. Subsequent to computation, a handover communication request is outputted to the base station 20 on the route ahead of the mobile station 10 by the wireless intercommunication function 11 when handover timing arrives (equivalent to S43 of FIG. 8), and handover processing is carried out.

Meanwhile, when the handover timing calculating function 23 is in the mobile station 10, the base station 20 does not have this function 23 (refer to FIG. 11).

Providing the handover timing calculating function 23 on the base station 20 side is advantageous in that the respective base stations 20 are connected to the network 100 and thus carry out the high-speed transfer of a computed handover timing and other such processing.

However, when a handover timing is sent to the mobile station 10 from a base station 20, there may be times when the reception field from the base station 20 located to the rear becomes weak for the mobile station 10 as it approaches the point where handover is scheduled to take place, and the mobile station 10 is not able to receive the handover timing information.

Providing the handover timing calculating function 23 on the mobile station 10 side eliminates this problem, making it possible for the mobile station 10 to obtain handover timing information at the optimal timing, enhancing the reliability thereof.

Furthermore, this calculating function 23 can also be provided in both the mobile station 10 and the base stations 20 (The constitution of the mobile station 10 would be as shown in FIG. 10, and that of the base station 20 would be as shown in FIG. 3.). In this case, realiability can also be enhanced by using either of the calculating functions 23 to coordinate the two calculated handover timings.

What is claimed is:

1. A mobile communication apparatus for communicating with a base station, comprising:
a setting unit which sets to a handover start-up timing from a first base station to a second base station a time which moves up by a start-up required time of an application, which is executed by a server to which the mobile communication apparatus is connected via either of the base stations and which is at least currently used, with respect to a estimated time for reaching a switching point of a radio intensity between the radio intensity from the first base station, with which the mobile communication apparatus communicates currently, and the radio intensity of the second base station, with which the mobile communication apparatus communicates next.

2. The mobile communication apparatus according to claim 1, wherein the setting unit sets the handover start-up timing on the basis of a velocity and acceleration of the mobile communication apparatus.

3. The mobile communication apparatus according to claim 1, wherein the start-up required time of the application is a time from at least an authentication process for the mobile communication apparatus in the server until the application can actually be executed on the mobile communication apparatus.

4. A mobile communication apparatus for communicating with a base station, comprising:
a notification unit which detects a velocity and acceleration of the mobile communications apparatus, and notifies a first base station, with which the mobile communication apparatus communications currently, of the detected velocity and acceleration; and
a setting unit which receives a handover start-up timing from a second base station, calculated by the second base station on the basis of the velocity and acceleration, by selected by the first base station the second base station, with which the mobile communication apparatus communicates next, based on the velocity and acceleration notified to the first base station, and by notified from the first base station to the second base station of the velocity and acceleration, and sets as a handover start-up timing for the second base station.

5. A base station for communicating with a mobile communication apparatus, comprising:
a receiving unit which receives a velocity information of a mobile communication apparatus from the mobile communications apparatus;
a calculating unit which calculates as a handover start-up timing of the mobile communication apparatus a time which moves up by a start-up required time of an application, which is executed by a server which the mobile communication apparatus is connected via either of the base station and which is at least currently being used, with respect to a estimated timing for reaching a radio intensity switching point, which is determined based on the received velocity information, of a radio intensity of a second base station with which the mobile communication apparatus communicates next; and
a sending unit which sends the calculated handover start-up timing to the mobile communications apparatus.

6. The base station according to claim 5, further comprising a notification unit which notifies information required for executing the application in the mobile communication apparatus to the second base station, with which the mobile communication apparatus communicates next, prior to the handover start-up timing.

7. The base station according to claim 5, further comprising a determination unit which determines the second base station with which the mobile communication apparatus communicates next, based on a direction of the mobile communication apparatus received from the mobile communication apparatus.

8. The base station according to claim 5, wherein the receiving unit receives acceleration information from the mobile communications apparatus, and the calculating unit calculates a estimated timing for arriving at the radio intensity transportation point based on the velocity and acceleration information.

9. The base station according to claim 5, wherein the start-up required time of the application is a time from at least an authentication process for the mobile communication apparatus in the server until the application can actually be executed on the mobile communication apparatus.

10. A mobile communications method for communicating a mobile communication apparatus with a base station, comprising a step of:
setting to a handover start-up timing from a first base station to a second base station a time which moves up by a start-up required time of an application, which is executed by a server to which the mobile communication apparatus is connected via either of the base stations and which is at least currently used, with respect to a estimated time for reaching a switching point of a radio intensity between the radio intensity of the first base station, with which the mobile communication apparatus communicates currently, and radio intensity of the second base station, with which the mobile communication apparatus communicates next.

11. A mobile communications program causing a computer of a mobile communication apparatus which communicates with a base station, to execute a processing, comprising:
a setting processing which sets to a handover start-up timing from a first base station to a second base station a time which moves up by a start-up required time of an application, which is executed by a server to which the mobile communication apparatus is connected via either of the base stations and which is at least currently used, with respect to a estimated time for reaching a switching point of a radio intensity between the radio intensity of the first base station, with which the mobile communication apparatus communicates currently, and radio intensity of the second base station, with which the mobile communication apparatus communicates next.

12. A communications method for communicating a base station with a mobile communication apparatus, comprising the steps of:
receiving a velocity information of the mobile communication apparatus from the mobile communications apparatus;
calculating as a handover start-up timing of the mobile communication apparatus a time which moves up by a start-up required time of an application, which is executed by a server which the mobile communication apparatus is connected via either of the base station and which is at least currently being used, with respect to a estimated timing for reaching a radio intensity switching point, which is determined based on the received velocity information, of a radio intensity of a second base station with which the mobile communication apparatus communicates next; and
sending the calculated handover start-up timing to the mobile communications apparatus.

13. A communications program causing a computer of a base station which communicates with a mobile communication apparatus, to execute a processing, comprising:
a receiving process which receive a velocity information of the mobile communication apparatus from the mobile communications apparatus;
a calculating process which calculates as a handover start-up timing of the mobile communication apparatus a time which moves up by a start-up required time of an application, which is executed by a server which the mobile communication apparatus is connected via either of the base station and which is at least currently being used, with respect to a estimated timing for reaching a radio intensity switching point, which is determined based on the received velocity information, of a radio intensity of a second base station with which the mobile communication apparatus communicates next; and
a sending process which sends the calculated handover start-up timing to the mobile communications apparatus.
